(19) United States
(12) Patent Application Publication
(10) Pub. No.: US 2001/0003936 A1
(43) Pub. Date: Jun. 21, 2001

(54) APPARATUS AND METHOD FOR SEPARATING CUT BLANKING PORTIONS FROM SHEET MATERIAL

(76) Inventor: BYUNG-JUN SONG, KWANGMYUNG-CITY (KR)

Correspondence Address: FRANK CHAU ESQ, F CHAU & ASSOCIATES LLP, 1900 HEMPSTEAD TURNPIKE, SUITE 501, EAST MEADOW, NY, 11554

(21) Appl. No.: 09/352,567

(22) Filed: Jul. 13, 1999

(30) Foreign Application Priority Data
Jul. 14, 1998 (KR) 98-28407

(51) Int. Cl. B26D 7/01

(52) U.S. Cl. 83/24; 83/25; 83/100

(57) ABSTRACT

An apparatus for separating cut portions from a sheet material such as paper or cardboard, and method thereof. The separation process is performed by using an air suction force to separate (from a sheet) a cut blanking portion and a rim portion having predetermined shapes. In one aspect, an apparatus comprises a pair of dispensers which receive a sheet therebetween between a pair of dispensers, approaches the pair of dispensers each other, absorbs a blanking portion with a first dispenser and a rim portion with a second dispenser, detaches the first and second dispensers each other, moves the first or second dispenser at a predetermined position, and releases the blanking portion and rim portion from the first and second dispensers, respectively. Thereby, the blanking portion and the rim portion can be readily separated and piled uniformly. The present invention advantageously has a simple structure and no need to make a new pair of molds for a new shape of blanking portion, which has been necessary for a conventional separating system.

### BACKGROUND

1. Technical Field

The present invention relates to an apparatus and method for separating cut blanking portions from a sheet in a cutter-creaser system, more particularly to an apparatus and method for separating cut blanking portions from a sheet using an air suction force.

2. Description of Related Art

During the manufacture of packing products (e.g., carton packs) using sheet material (such as paper or cardboard), a cutter-creaser system may be used for cutting one or more predetermined shapes (referred to herein as a “blanking portion”) into the sheet material and then separating the blanking portion from the sheet. FIG. 5 illustrates a conventional cutter-creaser system that may be employed for cutting and separating blanking portions from, e.g., a paper sheet. In general, the conventional cutter-creaser system 101 comprises a sheet piling unit 103 for piling a plurality of, e.g., paper or cardboard sheets, a feeding unit 105 for individually feeding the sheets 113 piled in the sheet piling unit 103 to a cutting unit 107. The cutting unit 107 cuts a sheet 113 fed from the feeding unit 105 into portions having predetermined shapes, such as a blanking portion 115 and a rim portion 117 around the blanking portion (as illustrated in FIG. 6). The conventional cutter-creaser system 101 further comprises a separating unit 109 for separating the blanking portion 115 from the rim portion 117, and a blanking portion piling unit (disposed within the separating unit 109) and a rim portion piling unit 111 for piling the separated blanking and rim portions, respectively. The blanking portion piling unit is generally disposed at the bottom of the interior of the separating unit 109.

FIG. 6 illustrates a sheet 113 being partitioned into a blanking portion 115 having folds 119 and a rim portion 117 around the blanking portion 115. The cutting unit 107 does not completely cut the blanking line 116 that partitions the blanking portion 115 and the rim portion 117. Instead, the cutting forms a perforation-like cut line. As such, a separation process must be performed to separate the blanking portion 115 from the rim portion 117.

FIGS. 7A and 7B are perspective views of a conventional apparatus for separating the blanking and rim portions from a sheet, which may be employed in the separating unit 109 of the conventional cutter-creaser system 101. As shown, the conventional separating apparatus comprises a pair of panel-shaped separating molds including an upper separating mold 123 and a lower separating mold 133. The upper separating mold 123 includes a pushing plate 125 having a shape that corresponds to the shape of the blanking portion 115. The lower separating mold 133 includes a receiving groove 135 having a shape that also corresponds to the shape of the blanking portion 115. The receiving groove 135 has a space for receiving the pushing plate 125 therein. The upper and lower separating molds 123 and 133 are arranged with respect to each other in a parallel and horizontal direction so as to be able to move towards and detach from each other. In particular, the upper separating mold 123 with the pushing plate 125 is disposed at an upper side, and the lower separating mold 133 with the receiving groove 135 is disposed at a lower side. As the upper separating mold 123 moves toward the lower separating mold 133, the pushing plate 125 is inserted into the space of the receiving groove 135.

Specifically, after a sheet has been cut and partitioned into a blanking portion and a rim portion via the cutting unit 107, the sheet is received by the separating unit 109, wherein it is placed on the lower separating mold 133. The upper separating mold 123 then descends upon the lower separating mold 133. As the upper separating mold 123 becomes sufficiently close to the lower separating mold 133, the pushing plate 125 of the upper separating mold 123 presses against the sheet on the lower separating mold 133. Since the pushing plate 125 and the receiving groove 135 have the same shape as the blanking portion 115 of the sheet, the pushing plate 125 pushes the blanking portion 115 of the sheet into the open space of the receiving groove 135, thereby separating the blanking portion 115 from the rim portion 117 surrounding the blanking portion 115. The separated blanking portion 115 then randomly falls into the blanking portion piling unit (in the bottom portion of the separating unit 109). The separated rim portion 117 remains on the lower separating mold 133, and is then transported to and piled in the rim portion piling unit 111.

There are disadvantages associated with the conventional apparatus discussed above for separating the cut blanking portions from a sheet. One problem is that the pair of separating molds 123 and 133 cannot be used for separating cut portions of the sheets that have shapes different from the shape of molds (i.e., when the shape of the pressing plate 125 and corresponding receiving groove is different from the shape of the blanking portion). Therefore, whenever the shape of a blanking portion is changed (e.g., for a new type of carton pack), a new pair of separating molds 123 and 133 must be made. In particular, a new upper mold 123 must be made to fit to the new shape of a blanking portion, and a new lower separating mold 133 must also be made to fit the new shape of the corresponding rim portion. Otherwise, the blanking and the rim portions of the sheet having a new shape cannot be separated using the old pair of separating molds. The process of making new separating molds is burdensome and increases the production costs of making carton packs and other packing products having different shapes.

Another problem associated with the conventional system is that the blanking portions are not uniformly piled. Specifically, as explained above, after being separated from sheets (via the pair of separating molds), the blanking portions are not uniformly piled, but randomly fall into the blanking portion piling unit. Therefore, it is necessary for the operator to physically pile the separated blanking portions in a uniform manner.

### SUMMARY OF THE INVENTION

The present invention is directed to an apparatus and method for separating cut portions (e.g., blanking and rim portions) from a sheet, wherein relatively simple structures or steps can be used reciprocally for separating cut portions having new shapes without requiring the production of new separating molds to fit the new shape. Accordingly, the burden and expense of producing packing products may be reduced. In addition, the present invention provides an apparatus and method for uniformly piling the cut portions of a sheet after a separation process.

In one aspect of the present invention, an apparatus for separating cut portions from sheet material (such as paper or cardboard) comprises a first dispenser; and a second dispenser; wherein the first dispenser and the second dispenser are configured for receiving a sheet therebetween and wherein the first dispenser and the second dispenser apply an air suction force to the sheet such that the first dispenser absorbs at least a first cut portion of the sheet and the second dispenser absorbs at least a second cut portion of the sheet to thereby separate the at least first and second cut portions.

In another aspect, the first dispenser comprises a first air discharge unit for allowing air to be discharged from the first dispenser; and a first cover plate having a plurality of holes, for absorbing the at least first portion when air is discharged air from the first dispenser, and the second dispenser comprises a second air discharge unit for allowing air to be discharged from the second dispenser; and a second cover plate having a plurality of holes, for absorbing the at least second portion when air is discharged air from the second dispenser.

In yet another aspect, the first dispenser further comprises a first template, attached to the first cover plate, having a shape which substantially blocks the holes of the first cover plate that do not correspond with a shape of the at least first cut portion, and the second dispenser further comprises a second template, attached to the second cover plate, having a shape which substantially blocks the holes of the second cover plate that do not correspond with a shape of the at least second cut portion.

These and other aspects, features and advantages of the present system and method will be described and become apparent from the following detailed description of preferred embodiments, which is to be read in connection with the accompanying drawings in which like reference symbols indicate the same or similar components.

### BRIEF DESCRIPTION OF THE DRAWINGS

FIG. 1 is a schematic diagram of a cutter-creaser system comprising an apparatus for separating cut portions of a sheet according to an embodiment of the present invention;

FIG. 2 is a cross sectional view at the line A-A of the cutter-creaser illustrated in FIG. 1;

FIG. 3 is an exploded view of components of the apparatus for separating cut portions of a sheet according to an embodiment of the present invention;

FIGS. 4A and 4B are planar views of upper and lower dispensers, respectively, shown in FIG. 3;

FIG. 5 is a diagram of a conventional cutter-creaser system comprising a conventional separating unit;

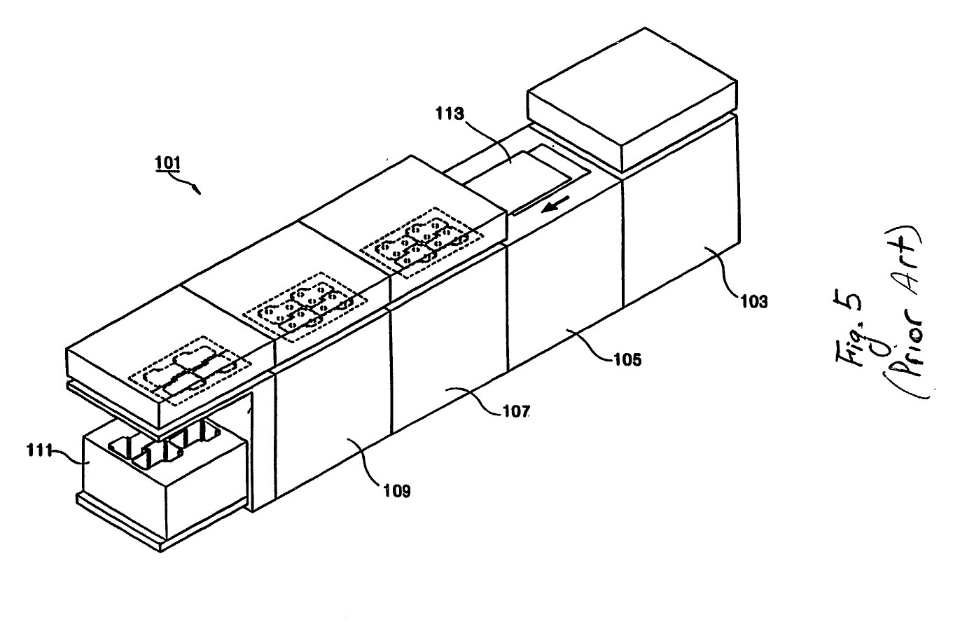

FIG. 6 is a perspective view of a sheet partitioned into cut portions such as blanking and rim portions; and

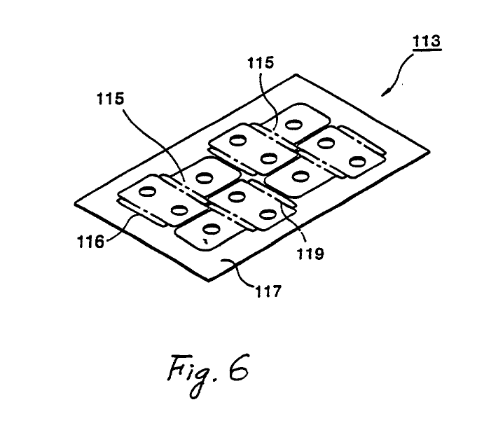

FIGS. 7A and 7B are perspective views of separating molds that are employed with the conventional separating unit of FIG. 5.

### DESCRIPTION OF PREFERRED EMBODIMENTS

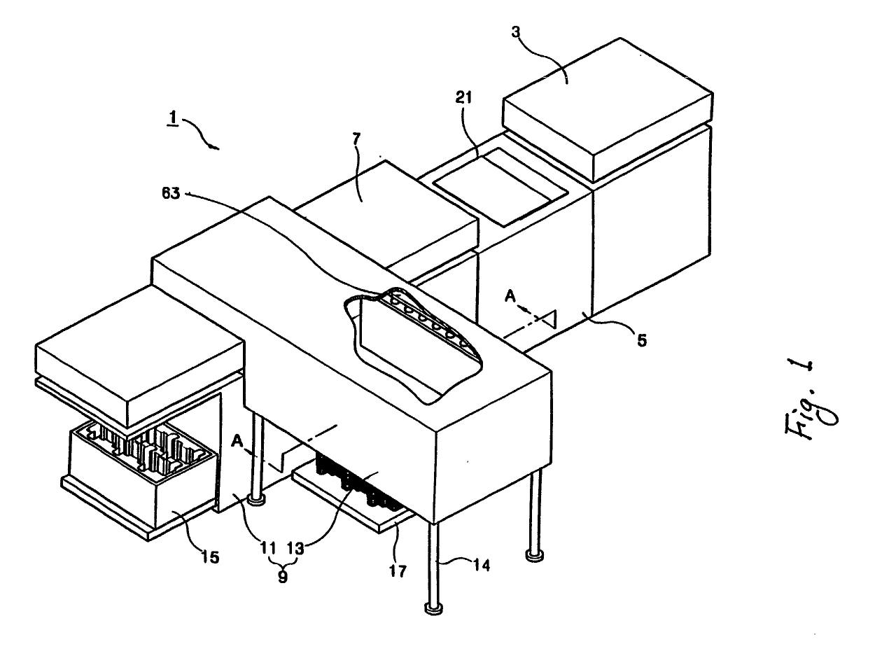

Referring now to FIG. 1, a diagram illustrates a cutter-creaser system comprising an apparatus for separating cut portions from a sheet according to a preferred embodiment of the present invention. It is to be understood that the cutter-creaser system 1 comprises a computer system having a controller which is programmed for controlling the operation of the system 1. The cutter-creaser system 1 comprises a sheet piling unit 3 for piling a plurality of sheets, a feeding unit 5 for feeding individual sheets in the sheet piling unit 3 to a cutting unit 7. The cutting unit 7 cuts a sheet 21 (supplied from the feeding unit 5) into one or more portions having predetermined shapes (e.g., a blanking portion having a carton pack shape and a rim portion surrounding the blanking portion). The system 1 also comprises a sheet separating unit 9 for separating the blanking and rim portions of the sheet 21, which are cut by the cutting unit 7. The system 1 further comprises a piling unit for piling the cut portions including a blanking portion piling unit 17 and a rim portion piling unit 15 for piling the blanking portions and the rim portions, respectively, after they are separated by the separating unit 9.

The sheet separating unit 9 according to the illustrative embodiment of the present invention comprises an exterior casing 11 and a frame 13 expanded from one side of the exterior casing 11. The blanking portion piling unit 17 is preferably disposed under the expanded frame 13. The exterior casing 11 portion of the separator unit 9 comprises a separating apparatus according to an embodiment of the present invention for separating the cut blanking and rim portions of the sheet 21 received from the cutting unit 7.

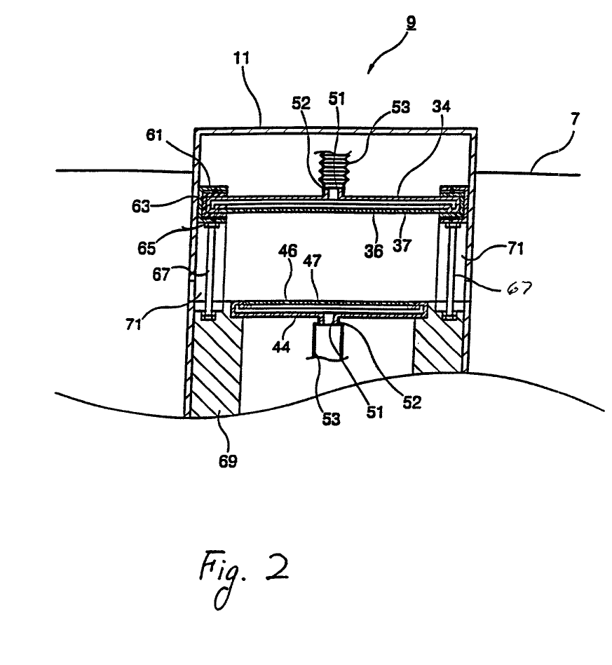

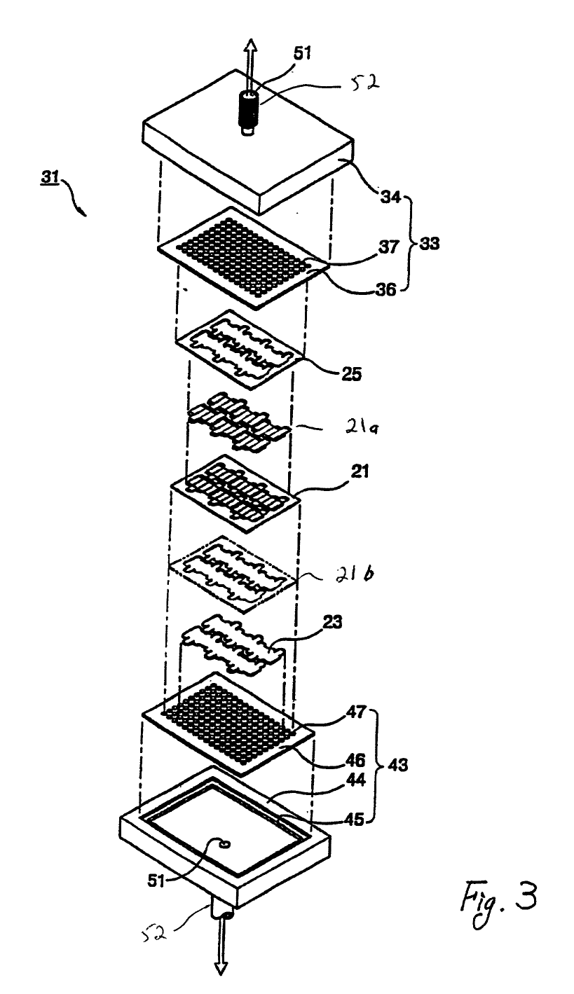

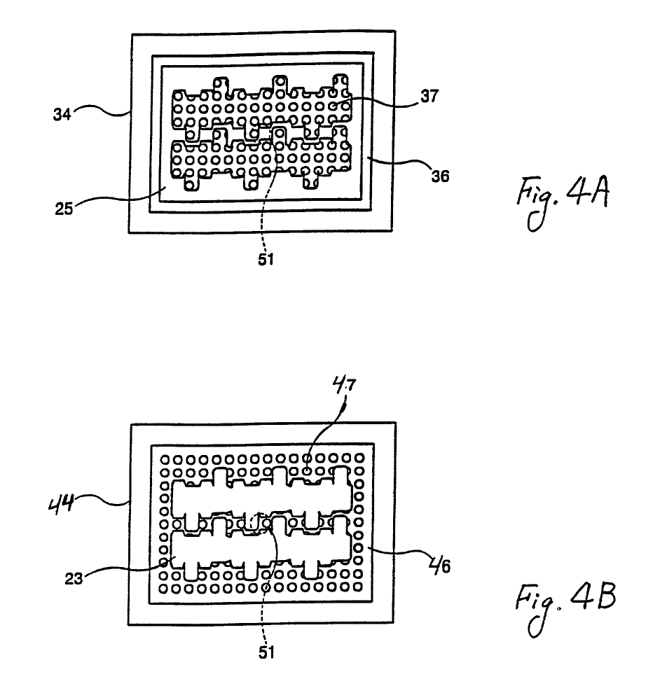

Referring now to FIGS. 2, 3, 4A and 4B, a detailed description of the separating apparatus according to an embodiment of the present invention (which may be employed in the separating unit 9) will now be provided. Particularly, FIG. 2 is a cross sectional view at line A-A of the cutter-creaser system 1 shown in FIG. 1. FIG. 3 illustrates a preferred embodiment of a separating apparatus 31 for separating cut portions from a sheet according to the present invention. FIGS. 4A and 4B are plane views of upper and lower dispensers of the separating apparatus 31 illustrated in FIG. 3.

Referring to FIGS. 3, 4A and 4B, the separating apparatus 31 of the present invention comprises an upper dispenser 33 and a lower dispenser 43. The upper dispenser 33 and the lower dispenser 44 are configured such that they can be moved towards and away from each other so as to be attached and detached. The upper dispenser 33 comprises a dispenser body 34 having an open space on one side (not shown), a cover plate 36 which is disposed in the open space of the dispenser body 34 and an air discharge unit 52 having an air inlet/outlet 51 disposed on a side opposite the side having the open space. Likewise, the lower dispenser 43 comprises a dispenser body 44 having an open space on one side 45, a cover plate 46 which is disposed in the open space 45 of the dispenser body 44 and an air discharge unit 52 having an air inlet/outlet 51 disposed on a side opposite the side having the open space 45.

The lower dispenser 43 is disposed in a horizontal direction within the exterior casing 11 of the separating unit 9 and in parallel with the upper dispenser 33. The lower dispenser 44 receives a sheet 21 provided from the cutting unit 7. The upper dispenser 33 disposed above the lower dispenser 43 with the open faces of the respective dispenser bodies 34 and 44 facing each other. During a separating process of the separating unit 9 using the separating apparatus 31 described herein, a blanking portion 23 and a rim portion 25 are attached to cover plates 36 and 46 having a plurality of piercing holes 37 and 47. For example, as illustrated in FIGS. 3, 4A and 4B, the rim portion 25 (or “upper template”) is attached to the upper cover plate 36 of the upper dispenser 33, and the blanking portion 23 (or “lower template”) is attached on the lower cover plate 46 of the lower dispenser 43. Accordingly, during a separation process when an air suction force is applied via the air discharge units 52, the upper dispenser 33 can absorb and separate the blanking portion 21a from the sheet 21, and the lower dispenser 43 can absorb and separate the rim portion 21b from the sheet 21 (as described in further detail below).

At least one side of the upper dispenser 33 is coupled to guide rails 61 disposed within the exterior casing 11 and extended along the expanded frame 13 (see FIGS. 1 and 2). The upper dispenser 33 reciprocally moves along the guide rail 61 (FIG. 2) in a longitudinal direction with the expanded frame 13. As such, the upper dispenser 33 can be moved back and forth between a location above the lower dispenser 43 (within the exterior casing 11) prior to a separation process and a location above the blanking portion piling unit 17 (within the expanded frame 13) subsequent to a separation process. An operating block 63 is disposed between the upper dispenser 33 and the guide rail 61, and can reciprocally slide along the guide rail 61 along its longitudinal direction.

A detailed description of an illustrative separation process (i.e., separating the cut blanking portion from the sheet) using the separating apparatus described above will now follow. Prior to the separation process, a blanking portion 23 (lower template) having a desired shape is attached to the lower cover plate 46 of the lower dispenser 43, and a rim portion 25 having a desired shape (upper template) is attached to the upper cover plate 36 of the upper dispenser 33. The cover plates 36 and 46 are then placed in their respective dispenser bodies 34 and 44 such that the upper and lower templates of the cover plates face each other.

Next, a sheet 21 having a cut blanking portion 21a and rim portion 21b, which substantially correspond in shape to the lower and upper templates 23 and 25, respectively, is placed on the lower dispenser 43 (i.e. over the lower template and cover plate 46). Next, the upper dispenser 33 is lowered to engage the lower dispenser 43. Once engaged, the air inside the upper and lower dispensers 33 and 43 is discharged through the respective air discharge units 52 to create an air suction force through the exposed holes of the upper and lower cover plates 36 and 46. The air discharge units 52 are preferably connected by air hoses 53 to any conventional system capable of absorbing and injecting air (e.g., an air compression system) through the inlet/outlets 51 of the air discharge units 52 under the control of the controller. The suction force created by the air discharge through the exposed piercing holes of the upper cover plate 36 causes the blanking portion 21a of the sheet 21 to be absorbed by the upper cover plate 36 (since the exposed piercing holes comprise a shape substantially corresponding to the shape of the blanking portion). Likewise, the suction force created by air discharge through the exposed piercing holes of the lower cover plate 46 causes the rim portion 21b of the sheet 21 to be absorbed by the lower cover plate 36 (since the exposed piercing holes of the lower cover plate 36 comprise a shape substantially corresponding to the shape of the rim portion).

Next, the upper and lower dispensers 33 and 43 are disengaged by vertically moving the upper dispenser 33 away from the lower dispenser 43, so that the blanking portion 21a attached to the cover plate 36 of the upper dispenser 33 and the rim portion 21b attached to the cover plate 46 of the lower dispenser 43 are separated. The separated blanking portion 21 a moves up with the upper dispenser 33, and the separated rim portion 21b remains on the lower dispenser 43. The upper dispenser 33 is then moved along the guide rail 61 in the expanded frame 13 by the operating block to a location above the blanking portion piling unit 17. The controller then causes the upper dispenser 33 to be gradually lowered by movement linkage elements 65, 67, and 71 to a desired position above the blanking portion piling unit 17. When the upper dispenser 33 is disposed at the desired position above the blanking portion piling unit 17, the controller causes the air absorbing/injecting system to stop discharging air from the dispensers 33 and 43 (via the air discharge units 52) and allow air to flow into the dispensers 33 and 43. As a result, the blanking portion 21a attached to the cover plate 36 of the upper dispenser 33 is released and uniformly piled in the blanking portion piling unit 17. The rim portion 21b remaining on the lower dispenser 43 is transported to and piled in the rim portion piling unit 15. The upper dispenser 33 is then returned to its initial position above the lower dispenser 43 within the exterior casing 11. The above described separation and piling procedure is then repeatedly performed for each received sheet 21.

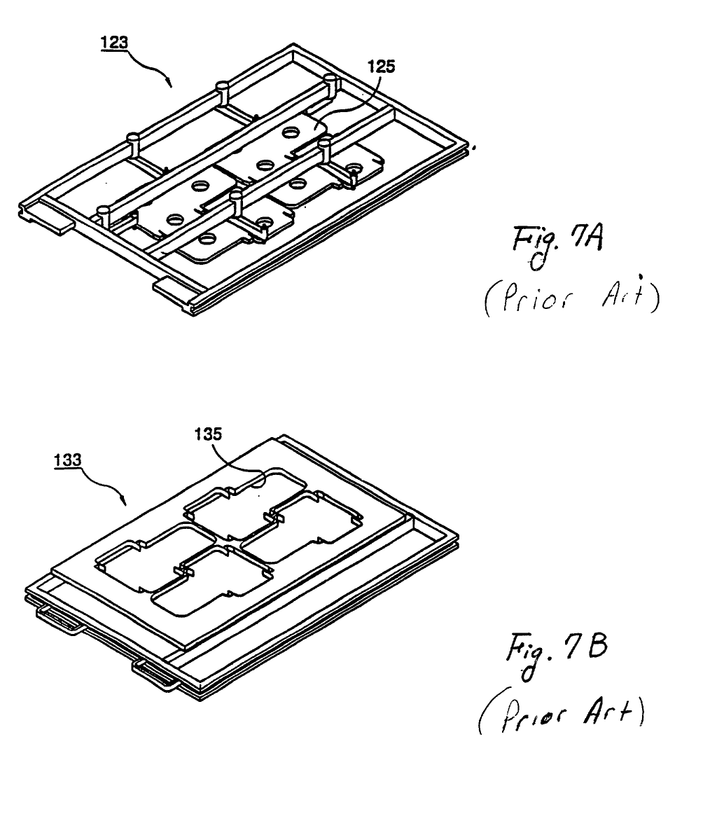

Advantageously, by using a separating apparatus in accordance with the teachings herein, the production of new separating is not required when the shape of the blanking portion 21a is changed (such as in the conventional device of FIGS. 7A and 7B). Indeed, the upper and lower dispensers 33 and 43 of the separating apparatus of the present invention may be used reciprocally for separating a blanking portion of a new shape. Instead, as explained above (and as shown in FIG. 3), a new pair of separating molds can be formed by simply attaching, for example, a new blanking portion 23 and a new rim portion 25 (templates) of desired shapes to the dispensers 33 and 43, respectively.

In addition, to enhance the effectiveness of the separating process, the speed of discharging air from the dispensers 33 and 43 can be increased. For this purpose, as explained above, the air absorbing/injecting system is preferably connected to the end of the air discharge unit 52, via a connecting hose 53, to thereby forcefully absorb or inject air (at a pressure suitable for the given application) from or into the dispensers 33 and 43. In addition, when the air absorbing/injecting system injects air into the dispensers 33 and 34, it is preferable to prevent the air from ejecting from the air discharge unit. Thus, for example, a check valve may be disposed between the air discharge unit 52 and the connecting hose 53 to control the flow of air.

Although illustrative embodiments have been described herein with reference to the accompanying drawings, it is to be understood that the present invention is not limited to those precise embodiments, and that various other changes and modifications may be affected therein by one skilled in the art without departing from the scope or spirit of the invention. All such changes and modifications are intended to be included within the scope of the invention as defined by the appended claims.

What is claimed is:

1. A method for separating cut portions of sheet material, comprising the steps of:
inserting a sheet between a first dispenser and a second dispenser, the sheet having at least a first cut portion and a second cut portion;
engaging the first and second dispensers;
discharging air from the first and second dispensers such that the first cut portion is absorbed by the first dispenser and the second cut portion is absorbed by the second dispenser.

2. The method of claim 1, further comprising the steps of:
inserting a first plate having a plurality of holes in the first dispenser; and
blocking a portion of the holes of the first plate so that the first cut portion is absorbed by an air suction force applied through an unblocked portion of the holes of the first plate.

3. The method of claim 1, further comprising the steps of:
inserting a second plate having a plurality of holes in the second dispenser; and
blocking a portion of the holes of the second plate so that the second cut portion is absorbed by an air suction force applied through an unblocked portion of the holes of the second plate.

4. The method of claim 1, further comprising the step of disengaging the first and second dispensers to separate the first and second cut portions.

5. The method of claim 4, further comprising the steps of:
moving the first dispenser to a predetermined position;
injecting air into the first dispenser to release the first cut portion; and
piling the first portion released from the first dispenser at the predetermined position.

6. The method of claim 1, wherein the first cut portion is a blanking portion of a predetermined shape and the second cut portion is a rim portion surrounding the blanking portion.

7. The method of claim 4, further comprising the step of injecting air into the second dispenser to release the second portion from the second dispenser.

8. An apparatus for separating cut portions from sheet material, comprising:
a first dispenser; and
a second dispenser;
wherein the first dispenser and the second dispenser are configured for receiving a sheet therebetween and wherein the first dispenser and the second dispenser apply an air suction force to the sheet such that the first dispenser absorbs at least a first cut portion of the sheet and the second dispenser absorbs at least a second cut portion of the sheet to thereby separate the at least first and second cut portions.

9. The apparatus of claim 8, further comprising means for engaging and disengaging the first and second dispensers each other, wherein the at least first and second cut portions of the sheet are separated when the first and second dispensers are disengaged.

10. The apparatus of claim 8, wherein the first dispenser comprises:
a first air discharge unit for allowing air to be discharged from the first dispenser; and
a first cover plate having a plurality of holes, for absorbing the at least first portion when air is discharged from the first dispenser.

11. The apparatus of claim 8, wherein the second dispenser comprises:
a second air discharge unit for allowing air to be discharged from the second dispenser; and
a second cover plate having a plurality of holes, for absorbing the at least second portion when air is discharged air from the second dispenser.

12. The apparatus of claim 10, wherein the first dispenser further comprises:
a first template, attached to the first cover plate, having a shape which substantially blocks the holes of the first cover plate that do not correspond with a shape of the at least first cut portion.

13. The apparatus of claim 11, wherein the second dispenser further comprises:
a second template, attached to the second cover plate, having a shape which substantially blocks the holes of the second cover plate that do not correspond with a shape of the at least second cut portion.

14. The apparatus of claim 8, further comprising means for discharging air from the first and second dispensers to create the air suction force.

15. The apparatus of claim 8, further comprising:
means for moving the first dispenser to a predetermined position;
means for injecting air into the first dispenser to release the at least first cut portion from the first dispenser; and
means for piling the at least first cut portion released from the first dispenser at a desired location.

16. The apparatus of claim 15, further comprising a check valve for controlling air flow between the air injecting means and the first and second dispensers.

17. A system for processing sheet material, comprising:
a cutter for cutting a sheet into at least a first portion and a second portion; and
a separator for separating the at least first and second portion of the sheet, the separator comprising a first and second dispenser, wherein the first dispenser and the second dispenser are configured for receiving a sheet therebetween and wherein the first dispenser and the second dispenser apply an air suction force to the sheet such that the first dispenser absorbs at least a first cut portion of the sheet and the second dispenser absorbs at least a second cut portion of the sheet to thereby separate the at least first and second cut portions.

18. The system of claim 17, further comprising guiding means for guiding at least one of the first and second dispensers to a desired location to uniformly pile cut portions that are attached thereto.
